(19) United States
(12) Patent Application Publication
(10) Pub. No.: US 2026/0340879 A1
(43) Pub. Date: Oct. 29, 2026

(54) METHOD FOR ENCODING AND DECODING A 3D POINT CLOUD, ENCODER, DECODER

(71) Applicant: Beijing Xiaomi Mobile Software Co., Ltd., Beijing (CN)

(72) Inventor: Shuo GAO, Beijing (CN)

(21) Appl. No.: 19/102,642

(22) PCT Filed: Aug. 11, 2022
(86) PCT No.: PCT/CN2022/111929

§ 371 Date: Feb. 10, 2025

(51) Int. Cl. G06T 9/00; G06T 9/40

(52) U.S. Cl. CPC G06T 9/001; G06T 9/40

(57) ABSTRACT

A method for encoding a 3D point cloud into a bitstream is implemented in an encoder. The method includes: obtaining nodes encompassing at least part of the point cloud at a depth d in a lexicographic order along each of axes X, Y, Z of a coordinate system; entropy encoding occupancy information of each node into a bitstream until a depth k, wherein k>=d; and entropy encoding trisoup information of each leaf node at a depth m into a bitstream, wherein the trisoup information includes information about presence and position of a vertex on edges of a volume associated with leaf nodes; wherein the entropy encoding of the occupancy information and the entropy encoding of the trisoup information are based on the same order and the depth m>k.

### CROSS-REFERENCE TO RELATED APPLICATIONS

The present disclosure is a U.S. National phase application of International Application No. PCT/CN2022/111929, filed on Aug. 11, 2022, the entire content of which is incorporated herein by reference.

### TECHNICAL FIELD

The present disclosure relates to a method for encoding a 3D point cloud into a bitstream. Additionally, it is an object of the present disclosure to provide a method for decoding a 3D point cloud from a bitstream. Further, it is an object of the present disclosure to provide an encoder and decoder, a bitstream encoded according to the present disclosure and a software. In particular, it is an object of the present disclosure to provide a method for reducing latency between occupancy tree encoding/decoding and trisoup encoding/decoding.

### BACKGROUND

As a format for the representation of 3D data, point clouds have recently gained traction as they are versatile in their capability in representing all types of 3D objects or scenes. Therefore, many use cases can be addressed by point clouds, among which are
movie post-production,
real-time 3D immersive telepresence or VR/AR applications,
free viewpoint video (for instance for sports viewing),
Geographical Information Systems (aka cartography),
culture heritage (storage of scans of rare objects into a digital form),
Autonomous driving, including 3D mapping of the environment and real-time Lidar data acquisition.

A point cloud is a set of points located in a 3D space, optionally with additional values attached to each of the points. These additional values are usually called point attributes. Consequently, a point cloud is combination of a geometry (the 3D position of each point) and attributes.

Attributes may be, for example, three-component colours, material properties like reflectance and/or two-component normal vectors to a surface associated with the point.

Point clouds may be captured by various types of devices like an array of cameras, depth sensors, Lidars, scanners, or may be computer-generated (in movie post-production for example). Depending on the use cases, points clouds may have from thousands to up to billions of points for cartography applications.

Raw representations of point clouds require a very high number of bits per point, with at least a dozen of bits per spatial component X, Y or Z, and optionally more bits for the attribute(s), for instance three times 10 bits for the colours. Practical deployment of point-cloud-based applications requires compression technologies that enable the storage and distribution of point clouds with reasonable storage and transmission infrastructures.

Compression may be lossy (like in video compression) for the distribution to and visualization by an end-user, for example on AR/VR glasses or any other 3D-capable device. Other use cases do require lossless compression, like medical applications or autonomous driving, to avoid altering the results of a decision obtained from the analysis of the compressed and transmitted point cloud.

Until recently, point cloud compression (aka PCC) was not addressed by the mass market and no standardized point cloud codec was available. In 2017, the standardization working group ISO/JCT1/SC29/WG11, also known as Moving Picture Experts Group or MPEG, has initiated work items on point cloud compression. This has led to two standards, namely d
MPEG-I part 5 (ISO/IEC 23090-5) or Video-based Point Cloud Compression (V-PCC) and
MPEG-I part 9 (ISO/IEC 23090-9) or Geometry-based Point Cloud Compression (G-PCC).

Both V-PCC and G-PCC standards have finalized their first version in late 2020 and will soon be available to the market.

The V-PCC coding method compresses a point cloud by performing multiple projections of a 3D object to obtain 2D patches that are packed into an image (or a video when dealing with moving point clouds). Obtained images or videos are then compressed using already existing image/video codecs, al-lowing for the leverage of already deployed image and video solutions. By its very nature, V-PCC is efficient only on dense and continuous point clouds because image/video codecs are unable to compress non-smooth patches as would be obtained from the projection of, for example, Lidar-acquired sparse geometry data.

The G-PCC coding method has two schemes for the compression of the geometry.

The first scheme is based on an occupancy tree (octree/quadtree/binary tree) representation of the point cloud geometry. Occupied nodes are split down until a certain size is reached, and occupied leaf nodes provide the location of points, typically at the centre of these nodes. By using neighbour-based prediction techniques, high level of compression can be obtained for dense point clouds. Sparse point clouds are also addressed by directly coding the position of point within a node with non-minimal size, by stopping the tree construction when only isolated points are present in a node; this technique is known as Direct Coding Mode (DCM).

The second scheme is based on a predictive tree, each node representing the 3D location of one point and the relation between nodes is spatial prediction from parent to children. This method can only address sparse point clouds and offers the advantage of lower latency and simpler decoding than the occupancy tree. However, compression performance is only marginally better, and the encoding is complex, relatively to the first occupancy-based method, intensively looking for the best predictor (among a long list of potential predictors) when constructing the predictive tree.

In both schemes, attribute (de)coding is performed after complete geometry (de)coding, leading to a two-pass coding. Thus, low latency is obtained by using slices that decompose the 3D space into sub-volumes that are coded independently, without prediction between the sub-volumes. This may heavily impact the compression performance when many slices are used.

An important use case is the transmission of dynamic AR/VR point clouds. Dynamic means that the point cloud evolves with respect to time. Also, AR/VR point clouds are typically locally 2D as they most of time represent the surface of an object. As such, AR/VR point clouds are highly connected (or said to be dense) in the sense that a point is rarely isolated and, instead, has many neighbours.

Dense (or solid) point clouds represent continuous surfaces with a resolution such that volumes (small cubes called voxels) associated with points touch each other without exhibiting any visual hole in the surface. An example of such a point cloud is shown on FIG. 1.

Such point clouds are typically used in AR/VR environments and are viewed by the end user through a device like a TV, a smartphone or a headset. They are transmitted to the device or stored locally. Many AR/VR applications use moving point clouds, as opposed to static point clouds, that vary with time. Therefore, the volume of data is huge and must be compressed. Nowadays, lossless compression based on an octree representation of the geometry of the point cloud can achieve down to slightly less than a bit per point (1 bpp). This may not be sufficient for real time transmission that may involve several millions of points per frame with a frame rate as high as 50 frames per second (fps), thus leading to hundreds of megabits of data per second.

Consequently, lossy compression may be used with the usual requirement of maintaining an acceptable visual quality while compressing sufficiently to fit within the bandwidth provided by the transmission channel while maintaining real time transmission of the frames. In many applications, bitrates as low as 0.1 bpp (10× more compressed than lossless coding) would already make possible real time transmission.

The codec VPCC based on MPEG-I part 5 (ISO/IEC 23090-5) or Video-based Point Cloud Compression (V-PCC) can achieve such low bitrates by using lossy compression of video codecs that compress 2D frames obtained from the projection of the point cloud on a plane. The geometry is represented by a series of projection patches assembled into a frame, each patch being a small local depth map. However, VPCC is not versatile and is limited to a narrow type of point clouds that do not exhibit locally complex geometry (like trees, hair) because the obtained projected depth map would not be smooth enough to be efficiently compressed by a video codec.

Purely 3D compression techniques can handle any type of point clouds. It is still an open question whether 3D compression techniques can compete with VPCC (or any projection+image coding scheme) on dense point clouds. Standardization is still under its way toward offering an extension (an amendment) of GPCC that would provide competitive lossy compression that would compress dense point clouds as good as VPCC intra while maintaining the versatility of GPCC that can handle any type of point clouds (dense, Lidar, 3D maps). This extension is likely to use the so-called TriSoup coding scheme that works over to an octree, as detailed in next sections. TriSoup is under exploration in the standardization working group JTC1/SC29/WG7 of ISO/IEC.

There are basically three main approaches to obtain a lossy scheme over the octree representation as done by the codec GPCC.
1. down-sampling+lossless+re up-sampling
2. modifying the voxels locally on the encoder side
3. modelling the point cloud locally.

The first approach basically consists in down-sampling the whole point cloud to a smaller resolution, lossless coding the down-sampled point cloud, and then re up-sampling after decoding. Many up-sampling schemes have been proposed (like super resolution, AI or learning-based 3D post-processing, etc) and may provide good PSNR results when the down-sampling is not too aggressive, say no more than a factor 2 in each direction. However, even if the metrics show good PSNR, the visual quality is disputable and not well con-trolled.

A second approach is to let the encoder “adjust” the point cloud locally such that the coding of the octree requires less bitrate. For this purpose, points may be slightly moved such as to obtain occupancy information better predicted by neighbouring nodes, thus leading to a lossless encoding of a modified octree with a lowered bitrate. Unfortunately, this approach leads to only small bitrate reduction.

The third approach is the most promising, but still requires some work before reaching maturity. The basic idea is to code the geometry by using a tree (an octree) down to some resolution, say down N×N×N blocks where N may be 4, 8 or 16 for example. This tree is coded using a lossless scheme, like GPCC for example. The tree itself does not require much bitrate because it does not go down to the deepest depth and has a small number of leaf nodes compared to the number of points of the point cloud. Then, in each N×N×N block, the point cloud is modelled by some local model. For example, a model may be a mean plane. Or it may be a set of triangles as in the so-called TriSoup scheme that is detailed in next sections.

### SUMMARY

It is an object of the present disclosure to provide a method for encoding of a 3D point cloud into a bitstream as well as a method for decoding geometry of a 3D point cloud from a bitstream with reduced latency between occupancy tree encoding/decoding and trisoup encoding/decoding.

The problem is solved by a method for encoding according to claim 1, a method for decoding according to claim 2, an encoder according to claim 9, a decoder according to claim 10, a bitstream according to claim 11 and a software according to claim 12.

In a first aspect a method for encoding a 3D point cloud into a bitstream, preferably implemented in an encoder is provided. A geometry of the point cloud being defined in an octree structure having a plurality of nodes having parent-child relationships and representing a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure and wherein an occupancy information associated with each respective child sub-volume indicates whether that respective child sub-volume contains at least one of the points, the method comprising:
obtaining nodes encompassing at least part of the point cloud at depth d in a lexicographic order along each of the axes X, Y, Z of the coordinate system;
entropy encoding the occupancy information of each node into a bitstream until depth k, wherein k>=d;
entropy encoding trisoup information of each leaf node at depth m into a bitstream, wherein trisoup information includes information about presence and position of a vertex on edges of the volume associated with leaf nodes;
characterized in that the entropy encoding of occupancy information and the entropy encoding of trisoup information are based on the same order and the depth m>k.

A point cloud is a set of points in a three-dimensional coordinate system. The points are often intended to represent the external surface of one or more objects. Each point has a location (position) in the three-dimensional coordinate system. The position may be represented by three coordinates (X, Y, Z), which can be Cartesian or any other coordinate system. Thus, according to the present disclosure, for a given depth d in the octree, the nodes are obtained in a lexicographic order. Preferably, the nodes are stored in a linked data structure (for instance a linked list). Therein, the linked data structure has elements connected to each other so that elements are arranged in a sequential manner. Preferably, a list Ld can be used to store the nodes and the nodes can be obtained iteratively from the list. With the lexicographic ordering (whatever is the axis ordering used in lexicographic order), the occupancy of any child volume with a lower z, a lower y or a lower x position may be used for contextualization. Therefore, the prediction is more stable with different child volume position in lexicographic order than the prior art (e.g., Morton order). Moreover, since the encoding order of the octree information and the encoding order of the trisoup information is the same, reordering process is not necessary anymore. Thus, the latency between occupancy tree encoding and trisoup encoding is reduced.

Preferably, the method further comprises storing occupied child nodes at depth d+1 in a lexicographic order. Thus, if the nodes at depth d are not leaf nodes, it is possible to continue traversing the octree in a lexicographic order. The child nodes in the next depth d+1 is already stored in a preferred order, thereby further facilitating the next iteration.

Preferably, the lexicographic order of nodes at depth d and/or the lexicographic order of nodes at depth d+1 is a raster scan order.

Preferably, the trisoup information decoding is in parallel with the occupancy information decoding at the last depth of occupancy information decoding. Preferably, the decoding process is implemented by two separate arithmetic decoders. Since the octree information and trisoup information may be in different sections of a bitstream, they are independent from each other and also the address of trisoup information is known for the decoder. Thus, the decoding process can be done by two decoders in parallel and further improve the decoding efficiency.

Preferably, the trisoup information encoding is in parallel with the occupancy information encoding at the last depth of occupancy information encoding with a latency being a subset of the leaf nodes. Since one edge may be shared be-tween several neighbouring leaf nodes, in trisoup coding, the vertex information for an edge may not be determined if only one node information is known. Further, since the nodes of octree encoding are in raster scan order, the trisoup encoding can start only after several nodes are coded by octree coding, it doesn't need to start after waiting for octree coding of all nodes at last depth finishing as that in prior art. The last depth of octree coding and trisoup coding can be implemented in parallel, and there are only several nodes delay between trisoup coding and last depth of octree coding.

Preferably, the occupancy information and the trisoup information are encoded into two independent sections of a bitstream, preferably the trisoup information starts on an addressable bit or byte of the bitstream. Thus, it is possible for the decoder to know the trisoup information starts from which position so that the decoding of the occupancy information and the trisoup information can be done in parallel. Preferably, a marker is used in the bitstream to locate the start of the trisoup information. Preferably, the address can be provided by a syntax element.

Preferably, the occupancy information and the trisoup information are encoded into or decoded from two separate bitstreams. With the two separate bitstreams, it simplifies processing at the encoder side.

In another aspect of the present disclosure a method for decoding a 3D point cloud from a bitstream, preferably implemented in a decoder is provided.

In another aspect of the present disclosure an encoder is provided for encoding a 3D point cloud into a bitstream. The encoder comprises a memory and a processor, wherein instructions are stored in the memory, which when executed by the processor perform the steps of the method for encoding described before.

In another aspect of the present disclosure a decoder is provided for decoding a 3D point cloud from a bitstream. The decoder comprises a memory and a processor, wherein instructions are stored in the memory, which when executed by the processor perform the steps of the method for decoding described before.

In another aspect of the present disclosure a bitstream is provided, wherein the bitstream is encoded by the steps of the method for encoding described before.

In another aspect of the present disclosure a non-transitory computer-readable storage medium is provided comprising instructions to perform the steps of the method for encoding a 3D point cloud into a bitstream as described above.

In another aspect of the present disclosure a non-transitory computer-readable storage medium is provided comprising instructions to perform the steps of the method for decoding a 3D point cloud from a bitstream as described above.

### BRIEF DESCRIPTION OF THE DRAWINGS

In the following, the present disclosure is described in more detail with reference to the accompanying figures.

FIG. 1 shows the dense point cloud longdress (courtesy of 8i), according to an embodiment.

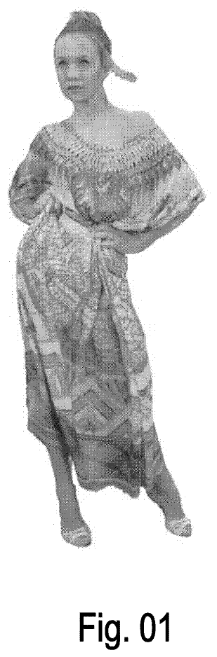

FIG. 2 shows TriSoup vertices (black dots) along the edges of volumes associated with leaf nodes, according to an embodiment.

FIG. 3 shows TriSoup triangles inside a leaf node, according to an embodiment.

FIG. 4 shows determining TriSoup triangles inside a leaf node, according to an embodiment.

FIG. 5 shows another construction of triangles when using another axis as dominant, according to an embodiment.

FIG. 6 shows ray tracing to render TriSoup triangles as a decoded point cloud, according to an embodiment.

FIG. 7 shows raster scan processing of parent nodes for raster scan coding of the occupancy of their child nodes, according to an embodiment.

FIG. 8 shows coding order of slice 0 and slice 1 of occupied nodes of same fixed x at current depth, according to an embodiment.

FIG. 9 shows an example of the decoder, according to an embodiment.

FIG. 10 shows an example of the encoder, according to an embodiment.

FIG. 11 shows an occupancy map (white cubes) known from previously encoded occupancy bits when encoding occupancy bit of a child node (striped cube) using a raster scan order, according to an embodiment.

FIG. 12 shows raster scan ordered parents nodes with 8 child occupancy bits coding and raster scan ordering of the child nodes, according to an embodiment.

FIG. 13 shows another example of the decoder using raster scan ordered parents nodes with 8 child occupancy bits coding together, according to an embodiment.

FIG. 14 shows another example of the encoder using raster scan ordered parents nodes with 8 child occupancy bits coding together, according to an embodiment.

FIG. 15 shows an occupancy map (white cubes) known from previously encoded or decoded occupancy bits when encoding or decoding occupancy bit of a child node (striped cube) using a raster scan order of the nodes but coding all the bits for the child nodes' occupancy using a Morton order, according to an embodiment.

FIG. 16 shows Raw byte sequence payload of a DU with Nu bytes, according to an embodiment.

FIG. 17 shows an example of vertex determination for an edge when child nodes are coded in raster scan order, according to an embodiment.

FIG. 18 shows an example of child nodes stored in buffer Ltris when trisoup coding starts for first child node, according to an embodiment.

FIG. 19 shows separate data units (DUs) for octree information and trisoup information, respectively, according to an embodiment.

FIG. 20 shows a schematic flow diagram of the method for encoding, according to an embodiment.

FIG. 21 shows a schematic flow diagram of the method for decoding, according to an embodiment.

FIG. 22 shows a schematic diagram of an encoder according to an embodiment.

FIG. 23 shows a schematic diagram of a decoder according to an embodiment.

### DETAILED DESCRIPTION OF THE EMBODIMENTS

TriSoup models the point cloud locally by using a set of triangles without explicitly providing connectivity information, thus its name derived from “soup of triangles”.

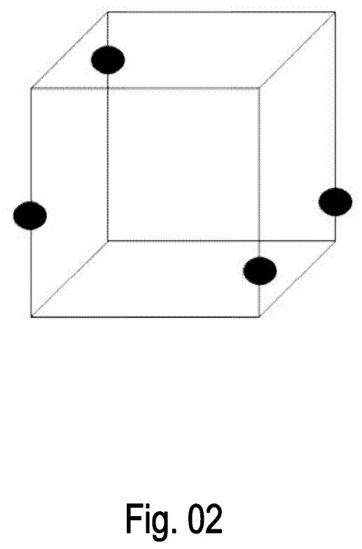

Vertices of triangles are coded along the edges of volumes associated with leaf nodes of the tree, as depicted on FIG. 2. These vertices are shared among leaf nodes having a common edge. This means that at most one vertex is coded per edge belonging to at least one leaf node. By doing so, continuity of the model is ensured through leaf nodes.

The coding of the TriSoup vertices requires two information per edge:
a vertex flag indicating if a TriSoup vertex is present on the edge, and
when present, the vertex position along the edge.

Consequently, the coded data consists in the octree data plus the TriSoup data. The increase of data due to the TriSoup model is more than compensated by the improvement of the reconstruction of the point cloud by TriSoup triangles as explained hereafter.

The vertex flag is coded by an adaptive binary arithmetic coder that uses one specific context for coding vertex flags. The position of a vertex on an edge of length N=2s is coded with unitary precision by pushing (bypassing/not entropy coding) s bits into the bitstream.

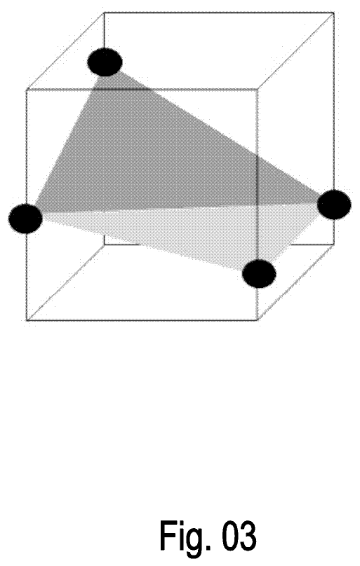

Inside a leaf node, triangles are constructed from the TriSoup vertices if at least three vertices are present on the edges of the leaf node. constructed triangles are as depicted on FIG. 3.

Obviously, other combinations of triangles are possible. The choice of triangles come from a three-step process
1. determining a dominant direction along one of the three axes
2. ordering TriSoup vertices depending on the dominant direction
3. constructing triangle based on the ordered list of vertices

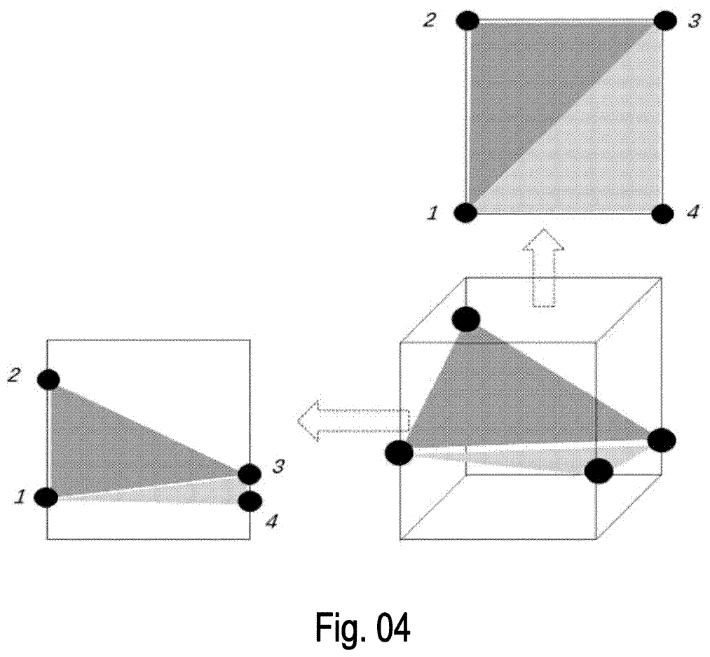

FIG. 4 will be used to explain this process. Each of the three axis is tested and the one maximizing the total surfaces of triangle is kept as dominant axis.

For simplicity of the figure, only the test over two axis is depicted on FIG. 4. A first test (top) along the vertical axis is performed by projecting the cube and the Trisoup vertices vertically on a 2D plane. The vertices are then ordered following a clockwise order relative to the center of the projected node (a square). Then, triangles are constructed following a fixed rule based on the ordered vertices. Here, triangles 123 and 134 are constructed systematically when 4 vertices are involved. When 3 vertices are present, the only possible triangle is 123. When 5 vertices are present, a fixed rule may be to construct triangles 123, 134 and 451. And so on, up to 12 vertices.

A second test (left) along a horizontal axis is performed by projecting the cube and the Trisoup vertices horizontally on a 2D plane.

The vertical projection exhibits the 2D total surface of triangles that is maximum, thus the dominant axis is selected as vertical, and the constructed TriSoup triangles are obtained from the order of the vertical projection, as in FIG. 4 inside the node.

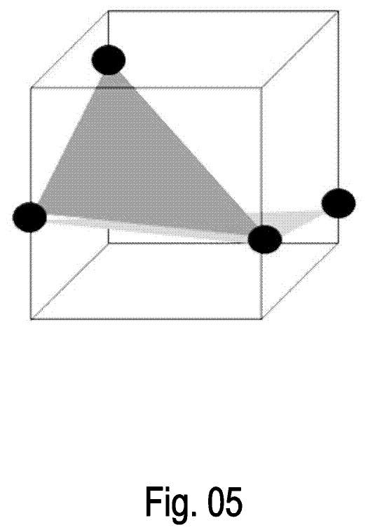

It is to be noted that taking the horizontal axis as dominant would have led to another construction of triangles as shown in FIG. 5.

The adequate selection of the dominant axis by maximizing the projected surface leads to a continuous reconstruction of the point cloud without holes.

The rendering of TriSoup triangles into points is performed by ray tracing. The set of all rendered points by ray tracing will make the decoded point cloud.

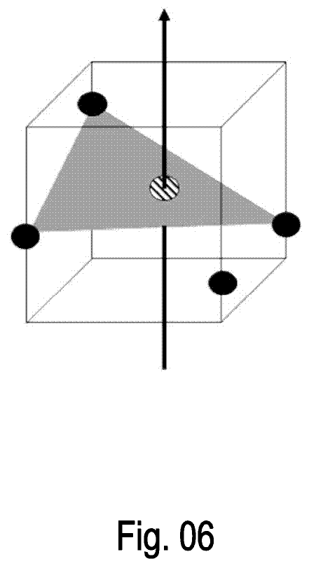

Rays are launched along the three directions parallel to an axis, as shown on FIG. 6. Their origin is a point of integer (voxelized) coordinates of precision corresponding to the sampling precision wanted for the rendering. The intersection (if any, dashed point) with one of the Trisoup triangles is then voxelized (=rounded to the closest point at the wanted sampling precision) and added to the list of rendered points.

After applying Trisoup to all leaf nodes, i.e., constructing triangles and obtaining points by ray tracing, copies of same points in the list of all rendered points are discarded (i.e., only one voxel is kept among all voxels sharing the same position and volume) to obtain a set of decoded (unique) points.

In prior art of lossy point cloud coding using trisoup method, a Morton ordering of the nodes is firstly used for lossless octree coding of nodes until a specified depth in the octree, after the octree geometry coding, then triangle soup representation is used on the leaf nodes for trisoup information. To encode/decode the trisoup information, which includes vertex presence flag and vertex position for each leaf node, the detail process follows the steps of:
Determine trisoup vertices for each node by
   Obtaining leaf nodes storing in list L_{d} by Morton-order;
   Iterating each leaf node in list L_{d} to determine the vertex presence flag and vertex position for each edge of each leaf node;
   After obtaining vertex information for each node, putting all leaf nodes' edges (with vertex information) into a list Lₛ;
   Sorting list Lₛ by the lexicographic order on the 3 x, y, z axes of edges;
   Finding unique edges by only keeping one edge for leaf nodes that sharing common edge and removing the other elements same as current edge from the sorted list Lₛ;
   Computing vertex (vertex presence flag and vertex position) for each unique edge that intersects the surface;
construct triangle and perform voxelization of triangle-based model to reconstruct geometry information of point cloud in both encoder and decoder, wherein the reordering process is also needed to get final vertex for each unique edge for triangle voxelization.
encode/decode vertex information for all leaf nodes into/from bitstream.

According to some methods, the child volume occupancy bits are encoded/decoded based on nodes in raster scan order at a given depth in the occupancy tree. Some uses raster scan order of the child volumes to code/decode their respective occupancy bits. Some uses the raster scan order of the nodes to code/decode the occupancy bits of all their respective child volumes (together) to get more optimal coding efficiency.

In 2D a raster scan order of the pixels is just a lexicographic ordering of the pixels according to their 2D coordinates x and y. A lexicographic order in (y, x) is usually used on images: pixels processing is ordered first by x then by y; pixels are ordered by increasing x coordinates for a given y coordinate and by increasing y coordinate. A 3D raster scan order is similar but in three-dimensional space (i.e., 3D raster scan order is a lexicographic order on an arrangement of the 3D coordinates.). A raster scan order of the voxels just follows a lexicographic order but in the three dimensions x, y, and z, for instance a lexicographic order in (z, y, x) may be used for volumetric images (or t, y, x for temporal sequences of images like in video).

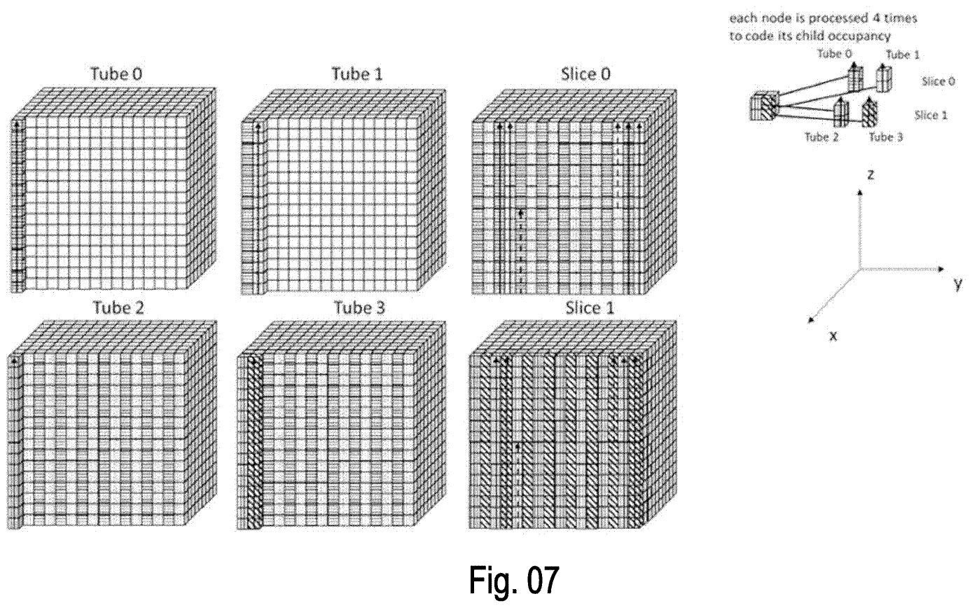

One example of the previously described method is illustrated in FIG. 7. For a better understanding, the full occupancy volume is represented in the figure, to better see the raster scan order of the processing. But one should understand that some part of the volume will not be coded/processed if ancestors' nodes have been indicated as unoccupied.

As shown in FIG. 7, a lexicographic order in (x, y, z) (i.e. a colexicographic order in (z, y, x)) is used. For a given depth in the octree, the child nodes' occupancy is coded following the raster scan order of the child nodes. To achieve raster scan order of child nodes, 4 tubes (tube 0, tube 1, tube 2, tube 3) for each node at current depth are defined, each tube being made from every node with a same x and y. And coding the occupancy bits of child nodes of tube 0 is performed by coding the occupancy bits b0 then b1 of all the occupied nodes with same fixed x and y, and the nodes being ordered by increasing z of all the occupied nodes. The coding of the occupancy tube 1 is then performed, by coding the occupancy bits b2 then b3 of the same nodes, and in the same order as for tube 0.

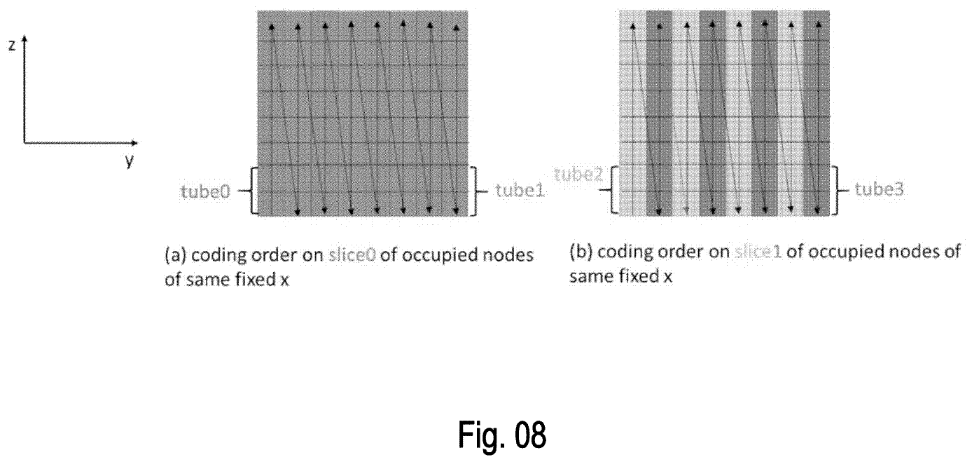

The coding process for coding occupancy tube 0 of all the occupied nodes with same fixed x and y and occupancy tube 1 of all the occupied nodes with same fixed x and y is repeated for every y, in increasing y order. It provides a raster scan coding of the slice 0 made of every bit b0, b1 b2, b3 of all the occupied nodes with same x. The illustration of raster scan order of slice 0 of these nodes is shown in FIG. 8(a), wherein each child node is represented in 2D to better illustrating. After coding the slice0 of the nodes at a fixed x, then it codes the slicel of these nodes at same x and the coding process of slice 0 is reproduced for slice 1, by successively coding in the same order, the occupancy tubes 2 then 3 made of occupancy bits b4 and b5 then b6, b7 of the same nodes. And the coding process of the illustration of raster scan order of slice 1 of these nodes is shown in FIG. 8(b) wherein each child nodes are represented in 2D to better illustrating. The coding process of slice 0 then slice 1, is repeated for every x of nodes at current depth, in increasing order, of all the occupied nodes.

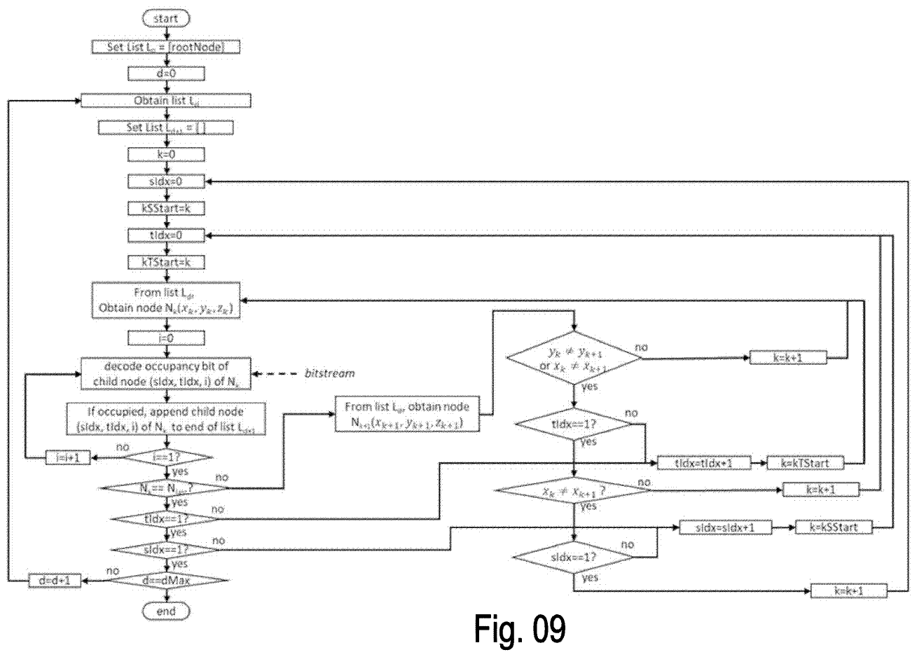

One example of the previously described decoder is shown in FIG. 9 as a block diagram, wherein a list L_{d} represents a list containing nodes Nₖ(xₖ, yₖ, zₖ) at a depth d in the octree, the nodes being ordered in raster scan order from N₀ to Nₗₐₛₜ, and k being the order index of the node in the list L_{d}. The FIG. 9 shows both
the process to decode occupancy of the child nodes (sIdx, tIdx, i) at depth d+1 from bitstream following raster scan order
and the process to put child nodes into list L_{d+1} to generate raster scan ordered nodes for next depth.

The variable sIdx represents the index of a slice of all the occupied nodes with a same x; the variable tIdx represents the index of a tube of all the occupied nodes with a same x and y; and the variable i represents the index of a child within each tube.

In other words, the integer value obtained from the binary word formed by (sIdx, tIdx, i) is the child index of a node (a decimal value from 0 to 7).

The variable kSStart is used to store the order index of the first node of a slice of all the occupied nodes with a same x; and the variable kTStart is used to store the order index of the first node of a tube of all the occupied nodes with a same x and y.

The depth dMax is the maximum depth in the tree and can be determined from the bitstream.

The detailed process in decoder can be described as below:
To Initialize the algorithm, by set the list L₀ to contain only the root node of the occupancy tree, and set the initial depth d to 0.
Label0
Obtain a (fifo) list L_{d} which stores nodes at depth d in raster scan order
Obtain an empty list L_{d+1} to produce raster scan ordered child nodes used for decoding of next depth;
Set node index k as 0 (initialize variable k with value 0)
Label1:
Set slice index sIdx as 0 (initialize variable sIdx with value 0)
Set first node index in the slice as k (initialize variable kSStart with value of k)
Label2:
Set tube index tIdx as 0 (initialize variable tIdx with value 0)
Set first node index in the tube as k (initialize variable kTStart with value of k)
Label3:
Obtain node Nₖ(xₖ, yₖ, zₖ) from list L_{d};
Set child index in the tube as 0 (Initialize variable i with value 0)
process0: decode and generate ordered child nodes for the child nodes in tube tIdx of slice sIdx of the node Nₖ in L_{d}.
   decode occupancy bit of the i-th child of tube tIdx of slice sIdx (which is child node (sldx, tIdx, i) of Nₖ) from bitstream
   If the the decoded bit indicate that the child is occupied, append a new node for the i-th child of tube tIdx of slice sIdx (which is child node (sIdx, tIdx, i) of Nₖ) at end of list L_{d+1}. This new node has coordinates (2×xₖ+sIdx, 2×yₖ+tIdx, 2×zₖ +i).
   If i is not equal to 1, increase i and repeat the process0, else got to next step
Judge if Nₖ is last node of depth d (i.e. last node of list L_{d}):
   If Nₖ is not last node of depth d, obtain next occupied node Nₖ₊₁(xₖ₊₁, yₖ₊₁, zₖ₊₁) from list L_{d}. Then judge if xₖ≠xₖ₊₁ or yₖ≠yₖ₊₁
      If xₖ≠xₖ₊₁ or yₖ≠yₖ₊₁, it means the next node does not belong to the same tube of occupied nodes having same x and same y. (Then judge if tIdx==1
         If tIdx==1 it means the processing of the two tubes of child nodes (in a tube of all occupied nodes with a same x and y) of the current slice of child nodes has been finished. Then judge if xₖ≠xₖ₊₁
         If xₖ≠xₖ₊₁ it means the next node does not belong to the same slice of occupied nodes having same x. Then judge if sIdx==1
         If sIdx==1 it means the processing of the two slices of child nodes (in a slice of all occupied nodes with a same x) has been finished. Nₖ₊₁ is thus the starting point of the next slice of occupied nodes, and of next tube of occupied nodes to be processed.
         Increase k by one and loop to Labell to start processing the first tube of child nodes of the first slice of child nodes of the next slice of occupied nodes.
         Otherwise sIdx==0. It means we can start processing the second slice of occupied nodes.
         Label4:
         Increase slice index sIdx by 1 and reset k to the index of the first node of the slice of all the occupied nodes with a same x: k=kSStart.
         Loop to Label 2 to start processing the third tube of child nodes.
         Otherwise xₖ==xₖ₊₁. it means the next node belongs to the same slice of occupied nodes, but to next tube of occupied nodes. Nₖ₊1 is thus the starting point of the next tube to be processed.
         Increase k by one and loop to Label2 to start processing the first tube of child nodes (belonging to the current slice sIdx of child nodes) of the next tube of occupied nodes.
         Otherwise tIdx==0. It means we can start processing the second tube of child nodes of the current slice of child nodes.
         Label5:
         Increase tube index tIdx by 1 and reset k to the index of the first node of the tube of all the occupied nodes with a same x and y: k=kTStart.
         Loop to Label 3 to start processing the second tube of child nodes.
      Otherwise xₖ==xₖ₊₁ and yₖ==yₖ₊₁. It means the next node belongs to the same tube of occupied nodes. Increase k by one and loop to Label3 to continue processing the same tube of child nodes.
   Otherwise Nₖ==Nₗₐₛₜ, the node is the last node at depth d. Then judge if tIdx==1.
      If tIdx==1 it means the processing of the last tube of child nodes of the current slice of child nodes has been finished. And next slice of child nodes (if remaining) may to be processed. Then judge if tIdx==1.
         If sIdx==1 it means the processing of the last slice of child nodes of the last slice of occupied nodes has been finished. And next depth in the occupancy tree (if remaining) may to be processed. Then judge if d==dMax.
         If d==dMax, it means the last depth of the occupancy tree has been decoded. The occupancy tree is then completed.
         Otherwise, d<dMax. It means the next depth of the occupancy tree can be processed. Increase depth d by one and loop to Label0 to process next depth in the occupancy tree.
      Otherwise sIdx==0. It means the processing of the second slice of child nodes of the last slice of occupied nodes may be started. Go to label4 to start it.
   Otherwise tIdx==0. It means the processing of the last tube of child nodes of the current slice of child nodes may be started. Go to label5 to start it.

The List L_{d+1} can be omitted, and the child nodes are not appended to that list when d==dMax, because the list will not be used since no more depth will be processed.

The coordinates of a child node are the coordinates of its parent nodes refined by one bit of precision. In other words some physical spatial coordinates of the center of a node could be obtained by multiplying the coordinates of the center of the node by the physical dimensions of the node's volume scaled according to the depth:

((xₖ, yₖ, zₖ)+(0.5, 0.5, 0.5))×(width, length, height)/2^{depth}

Preferably, when d==dMax, if child nodes are occupied, points with coordinates ((2×xₖ+sIdx, 2×yₖ+tIdx, 2×zₖ+i)+(0.5, 0.5, 0.5))×(width, length, height)/2^{dMax} are output (for instance in a buffer). It produces raster scan ordered points geometry.

From the above coding process of child nodes, it is observed that each node Nₖ needs to be accessed/processed 4 times: the first time it is accessed/processed is for coding the occupancy tube 0, the second time is for coding the occupancy tube 1, the third time is for coding the occupancy tube 2 and the last time is for coding the occupancy tube 3.

The mentioned orderings of the nodes Nk-that are needed by this coding process to build a raster scan ordering of the child nodes occupancy are al-ready obtained from the raster scan ordering of the processed nodes. And the raster scan ordering of the nodes is directly obtained from the raster scan ordering of the child nodes occupancy coding made for parent nodes (i.e. during the previous depth of the octree occupancy coding).

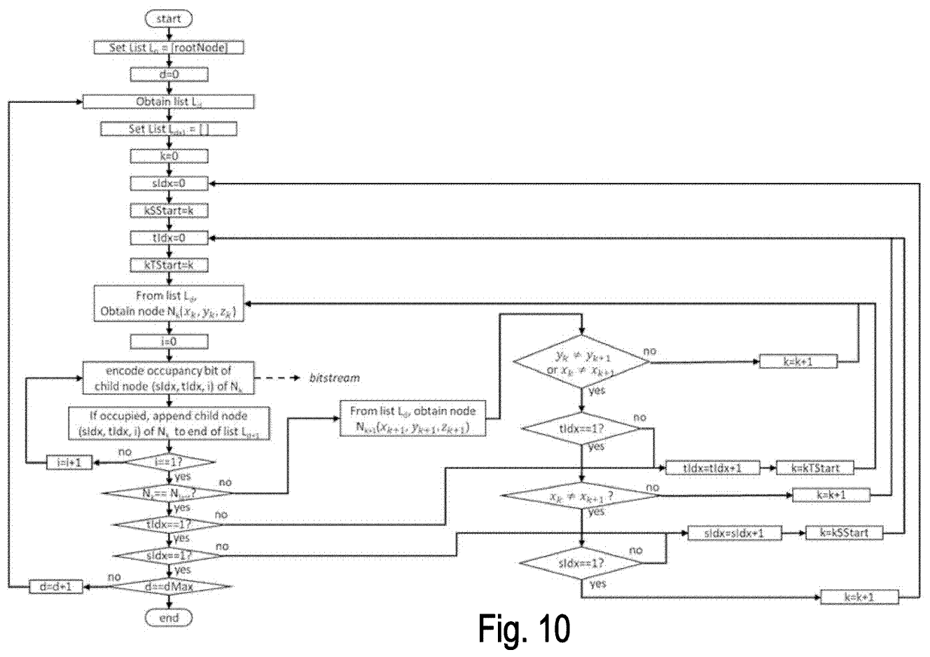

One example of the previously described is shown in FIG. 10 as a block diagram.

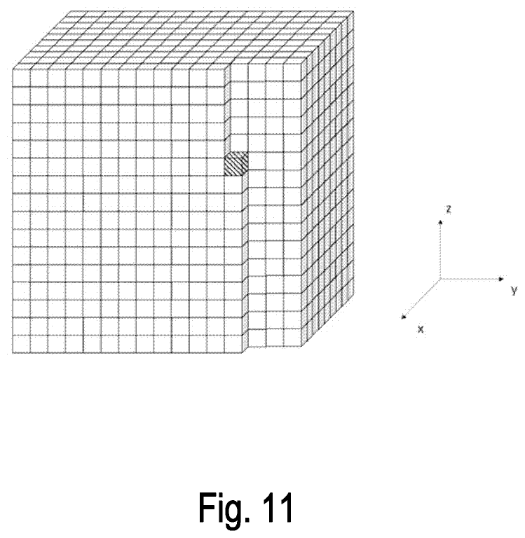

The effect of the previously described method is shown in FIG. 11, which shows the occupancy map coverage of child volumes already known when coding the occupancy bit for the striped child volume, when the occupancy bits are coded following raster scan order of the child volumes of the nodes. FIG. 11 also permits to see the neighbouring positions that can be used to build contexts for entropy coding of the occupancy bit. With the raster scan ordering (whatever is the axis ordering used in lexicographic order), the occupancy of any child volume with a lower z, a lower y or a lower x position may be used for contextualization. A predetermined pattern of neighbouring child volumes may thus be defined and can be used to select coding context for any coded occupancy bit.

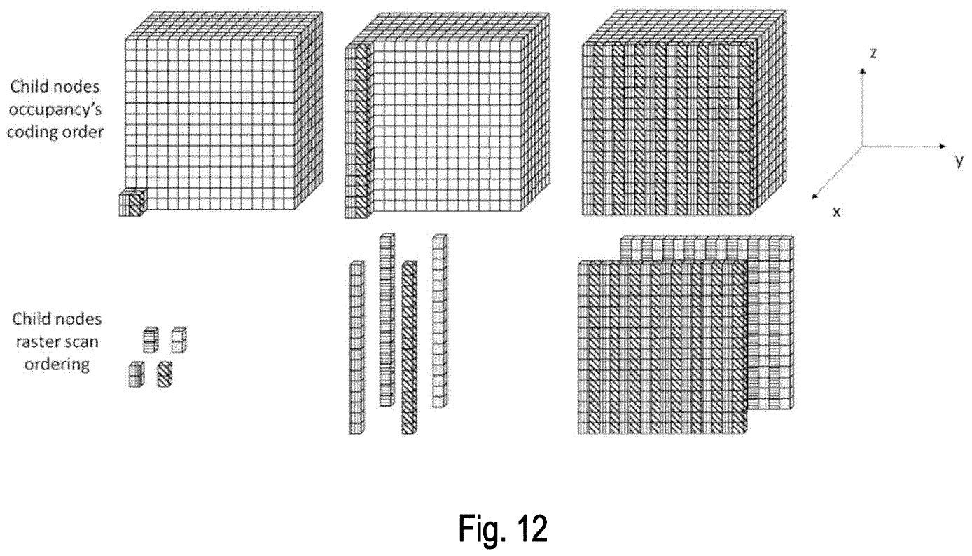

According to another example, the method may use the raster scan order of the nodes to code/decode the occupancy bits of all their respective child volumes (together) at a given depth in the occupancy tree. In this embodiment, as illustrated in FIG. 12, occupied nodes are processed in raster scan order, but the occupancy bits for all the child volumes of the nodes are successively coded by an order in a single pass on the node, for instance using Morton scan ordering of the child nodes occupancy bits (it means code the child volumes of each node using Morton order in a single pass on the node); and to order the child nodes by raster scan order for next depth, it uses child nodes ordering method same as that in the first embodiment, which uses 4 passes on each node at current depth and is shown in FIG. 9.

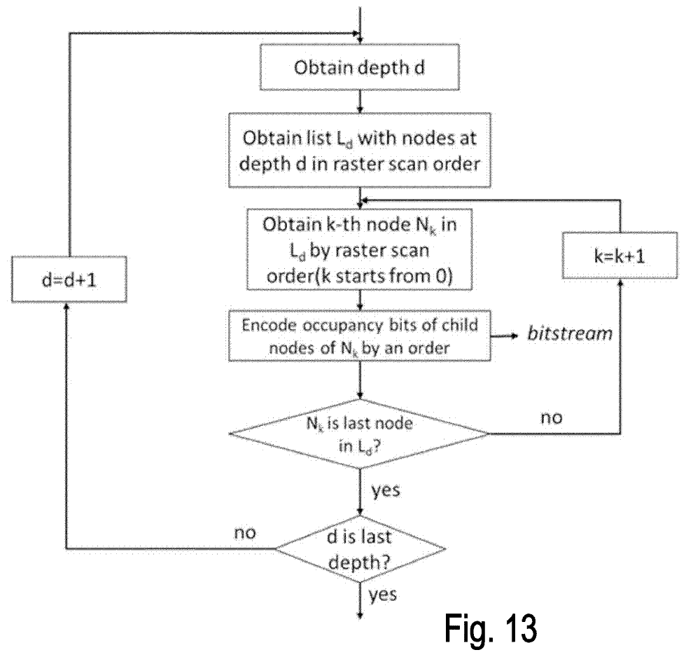

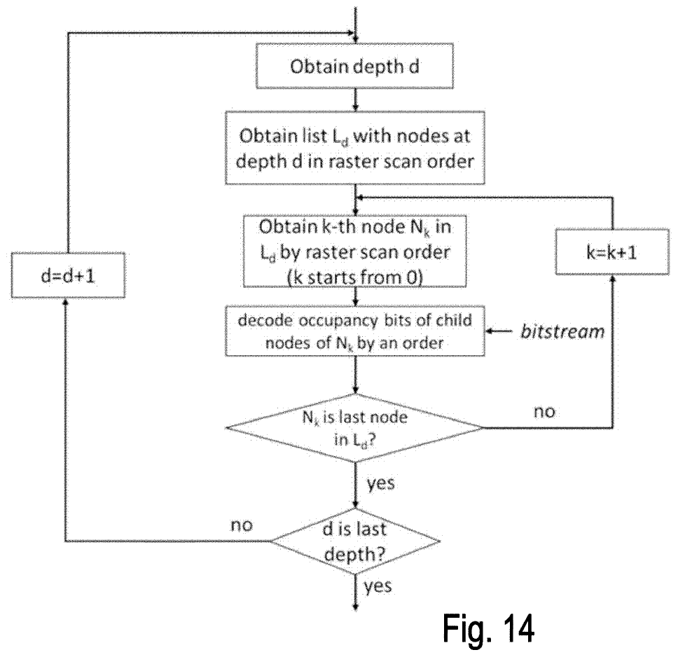

FIG. 13 shows an example of child nodes occupancy decoding process of decoder in this embodiment, and FIG. 14 shows an example of the encoder of the this embodiment, and the ordering process of child nodes is not shown in both FIG. 13 and FIG. 14.

The detailed process in encoder/decoder can be described as below:
Obtain a fifo list Ld storing nodes at depth d by raster scan order
Obtain node Nₖ(xₖ, yₖ, zₖ) at depth d from the fifo list L_{d}, and initially at each depth it starts from the first node N₀(x₀, y₀, z₀),
decode/encode its child nodes occupancy bits by an order, like Morton order, from/into bitstream,
if Nₖ is not last node in the fifo list L_{d}, go to encode/decode next node Nₖ₊₁(xₖ₊₁, yₖ₊₁, zₖ₊₁) in the fifo list L_{d} until it reaches the last node in L_{d},
go to encode child nodes occupancy of next depth until it reaches the final depth.

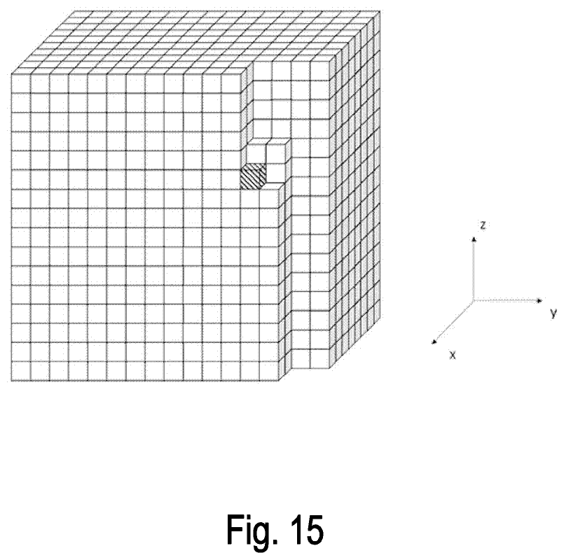

FIG. 15 shows the occupancy map of child nodes already known when coding the occupancy bit for the striped child volume when using the alter-native coding order described for FIG. 7. With the raster scan ordering of the nodes (whatever is the axis ordering used in lexicographic order), the occupancy of any child volume of a node with a lower z, a lower y or a lower x position than the current node (parent node of the striped child volume) may be used for contextualizing entropy coding of the striped child volume occupancy bit, as well as any child volume occupancy bits previously coded for the current node. With this approach, we can clearly distinguish there is one different pattern for the available neighbouring nodes for each position of the coded child volume occupancy. Thus, with octree occupancy there are 8 different patterns. The entropy coding of the occupancy bits thus needs to be tuned according to each pattern (i.e. for each occupancy bit index) in order to be more optimal.

It complexify a bit the encoding with respective to the first embodiment, but is still more optimal than the patterns in octree with nodes coded in Morton order as that in prior art. In the prior art, with Morton ordering of the nodes, the pattern for “unknown” (i.e. not yet coded) neighbouring nodes occupancy vary much more with the positions in the ancestor nodes (and so with the Morton index), thus some neighbouring information is not always reliable when building the entropy contexts and it may introduce bias in entropy coding probabilities built in adaptive entropy coding context, thus reducing the coding performances.

It should be understood that in point cloud coding, the occupied nodes and child nodes would rarely (and preferably never) be as dense as in example FIG. 7, FIG. 11, FIG. 12 and FIG. 15. These figures are densely represented to provide a better view of the causal child occupancy information available and of the nodes/child nodes processing order. In usual point clouds several volumes will be unoccupied, and so, no nodes for these volumes will exist and will be processed. The processing order of the occupied nodes re-main the same as if the content was dense, and for a given occupied node the occupancy of all the children volumes is always coded, but the unoccupied nodes/volumes are not processed at all because they are not present in the tree structure. In comparison to the processing order of a dense content, the processing of these unoccupied nodes/volume is just skipped.

As is described above, in lossy point cloud coding using trisoup method, assume the leaf node is at depth d, firstly the lossless octree geometry coding are based on Morton ordered nodes at a depth d−1 and it generates Morton-ordered leaf nodes at depth d storing at list L_{d}. Then, triangle soup representation is used on the leaf nodes to produce trisoup information, during which a process of sorting edges of all leaf nodes are needed since they are generated by using Morton scan ordered leaf nodes and the edges used for vertex information should be in raster scan order. After sorting the edges of all leaf nodes by raster scan order (i.e. a lexicographic order on the 3 x, y, z axes)), then trisoup coding is performed. So, a reordering step is needed between octree coding and trisoup information coding, to move from Morton order to raster scan order.

Drawbacks of current trisoup coding method:

This reordering process is costly, in terms of computation and memory access, and introduces latency: the processing of trisoup edges requires that most (or even all, with current design) of the last depth of the occupancy tree has been decoded before being able to get reordered nodes, and so, before being able to start processing trisoup information for reconstructing the point cloud. In addition,
the reordering happens not only in one place during trisoup coding process, it happens in both the vertex determination process and the trisoup voxelization process, so it is much costly in computation complexity and causes much delay between octree coding and trisoup coding;
and also especially on decoder side: since the octree nodes are decoded and stored in Morton order, the decoder needs to decode most of the octree information of the last depth before being able to start processing trisoup.

Moreover, according to existing solutions, the encoded trisoup information comes into the bitstream after occupancy tree information in such a way that it is not possible to encode or decode encoded trisoup information without having precedingly finished encoding or decoding the occupancy tree in-formation: there is no CABAC reset between the two bitstream sections. Thus, the problem to solve is how to reduce latency between occupancy tree encoding and trisoup encoding, and between occupancy tree decoding and trisoup decoding.

To solve the problems described above, the proposed solutions are
using the same ordering of the nodes for both octree and trisoup information coding. For instance, Morton ordering for both or preferably raster scan ordering for both, because raster scan order is more convenient, especially for trisoup coding;
and coding octree information and trisoup information into two independently accessible sections of the bitstream.

By doing so, the need to wait for a reordering is removed, and the encoding/decoding of trisoup information may be start before occupancy tree encoding/decoding is finished. Part of the encoding/decoding of trisoup information may thus be performed in parallel of octree coding (occupancy tree).

Thus, latency between occupancy tree encoding and trisoup encoding, and between occupancy tree decoding and trisoup decoding can be reduced according to the present disclosure.

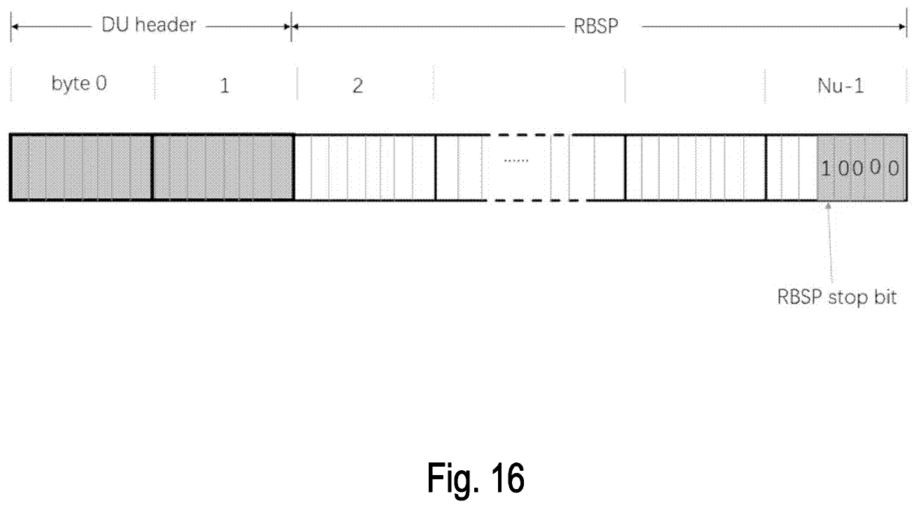

In the first embodiment, in addition to using the same ordering of the nodes for both octree and trisoup, for instance raster scan order(in a variant Morton order could be used as well), the trisoup information and the octree infor-mation are both in the separate parts of the same data unit (DU) for a point cloud slice, an example of DU is shown in FIG. 16. As is shown in FIG. 16, the payload of a data unit (DU) is a sequence of Nu bytes. The first two bytes contain the DU header, the remaining bytes are referred to as the raw byte sequence payload (RBSP). The last byte of the RBSP containing coded data includes the RBSP stop bit(‘1’) followed by ‘0’ bits such that byte alignment is achieved.

However, trisoup information needs to start on an addressable bit or byte in the bitstream (DU): in one example, the cabac coder is flushed between octree and trisoup information coding(cabac flushing is the action of putting remaining bits that may be in a cabac buffer and outputting any additional bit that would be required by the decoder to be able to perform a correct decoding of the last binary symbol encoded before the flushing). After flushing, the cabac coder is then reset, so that a cabac decoder can start decoding from the following bit in the bitstream (in byte alignment variant, padding bits are inserted after the flushed bits to that the decoder can start decoding from next byte, in some other variant padding bytes may also be inserted to align first byte to multiples of bytes). Thus, both encoder and decoder can start encoding/decoding the trisoup information to/from the bitstream, starting from the starting bit/byte position and using the freshly initialized entropy encoder/decoder. To let the decoder know where the trisoup information bit-stream starts, an addressable bit or byte is needed to be signaled/indicated to decoder. And to signal/indicate the decoder where the trisoup information bitstream starts in the DU, there are two example methods:
1. One example method is to use a marker and put the marker in the bitstream to locate start of trisoup information, wherein a marker is a sequence of bits that are not allowed in the bitstream (for something else than markers), for example, a sequence of 32 bits with each bit being ‘0’ is not allowed by the system, so it can be used as a marker to signal the decoder to start another part of bitstream to locate specific bitstream in a DU. Usually when this sequence of bits should have been output by the encoder, another reserved symbol (for instance a sequence of 31 bits equal to 0 and 1 bit equal to 1) is used as an escape sequence, and when it is encountered the following bit in the bitstream replaces the last bit: 31 bits equal to 0 followed by 1 bit equal to 1 and one bit equal to 0 indicates to the decoder that it must use a sequence of 32 bits equal to 0; and 31 bits equal to 0 followed by 2 bit equal to 1 indicates to the decoder that it must use a sequence of 31 bits equal to 0 and 1 bit equal to 1. Usually, a marker uses byte alignment and is set as 4 bytes sequence, wherein each byte has 8 bits. And the marker can be put at the end of the octree information bitstream to start the trisoup information bitstream in a DU at the encoder and at the decoder, after decoding the marker, it knows that the following bitstream need to be decoded by an initialized entropy decoder.
2. The other example method is to provide the address of the bit or byte in a syntax element, for instance in the DU header of a point cloud slice, to easily locate the bit or byte for starting of trioup information bitstream. And the address of the bit or byte can be obtained by calculating the offset between the bit or byte and the beginning bit or byte of the DU. And the DU header is shown in FIG. 16.

Decoding method in the first embodiment:

Since the octree information and trisoup information are in different sections of bitstream, and the bit or byte address of trisoup information is known for the decoder, so the first embodiment allows parallel decoding of octree and trisoup information by decoding them using two separate arithmetic decoders, one decoder is for octree decoding and the other decoder is for trisoup decoding. The parallel decoding of the bitstream can be performed independently when entropy coding of trisoup information (vertices presence flags and vertices position) does not depend on the nodes' geometry. After decoding the occupancy information of octree and trisoup information of leaf nodes (like vertex presence flag and vertex position), the voxelization of trisoup triangle is implemented to reconstruct point cloud data.

Decoding method in a variant:

However, in most recent version of trisoup the compression of trisoup information uses local nodes' geometry. And so, some dependencies are introduced between the occupancy information and trisoup information. In any case, the determination of the localization of the edges, and the voxelization of trisoup triangles (and so the reconstruction of point cloud data) locally depends on nodes' geometry and on the trisoup information of leaf nodes. Thus, a dependency between nodes' geometry and trisoup exists. And this dependency only introduces a small amount of latency if one wants to perform the three tasks (decoding of occupancy information of the last depth, decoding of trisoup information and voxelization) in parallel. For instance, this latency is roughly one slice of leaf nodes (i.e. all the leave nodes having for instance same x and y) for entropy coding of trisoup information when entropy coding context of a vertex information depends on occupancy of all the nodes surrounding the corresponding edge; and two slices of leaf nodes to get all the surrounding edges of a node when performing voxelization.

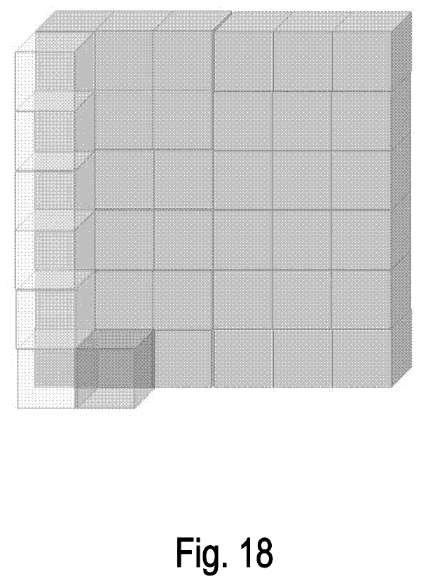

In an example of parallel octree and trisoup decoding in this variant, wherein the child nodes are coded in raster scan order (e.g., FIGS. 7-9) . Assume leaf nodes are at depth d in octree, it uses octree decoding for occupancy tree of nodes until depth d−1, and uses trisoup decoding to decode trisoup in-formation of leaf nodes at depth d, the proposed decoder follows these steps:
Firstly, obtain octree information bitstream and trisoup information bitstream
Then, it uses octree decoding to decode the occupancy of nodes in raster scan order until depth d−1, and also during this process child nodes of nodes at depth d−2 are put into a list L_{d-1}, so it can obtain a list L_{d-1} storing nodes in raster scan order, which can be used for last depth of octree decoding, which is at depth d−1;
Then for nodes at depth d−1, the octree decoding of nodes crosses with trisoup decoding by making use of the advantage of raster scan ordered nodes. For an example, in detail,
   Obtain a list L_{d-1} storing nodes at depth d−1 in raster scan order;
   Process node Nₖ (k starts from 0) from the list Ld−1, and decode occupancy of its child nodes (leaf nodes) in raster scan order from bitstream.
      From the start of decoding the first child node, the node information of each child node is stored in a buffer Ltris after it is decoded by octree coding, which can be used for trisoup decoding of these already decoded child nodes.
      And when the sIdx and tIdx of current child node satisfy the condition (which is sIdx=1 and tIdx=1) for the first time, after current child node is decoded, the trisoup coding starts from the first child node (whose sIdx and tIdx are 0) of N₀, which is also the first child node in L_{d}. So the buffer Ltris stores node information of
         child nodes of a slice of nodes with same x and a tube of nodes with same x and y, which locates in raster scan order before current child node,
         and current child node,
         and they are shown in FIG. 18, wherein the transparent green node represents the current child node, and the nodes in transparent pink, yellow and orange are child nodes that are already decoded. After octree decoding of the current child node, put its information into buffer Lₜᵣᵢₛ if it's occupied, then information of all neighbouring child nodes of first child node is known, the vertex determination of each edge of first child node (which is first leaf node) in list Ld can be done, so the trisoup decoding can be started from this child node.
      Then decode the next child node stored in list Ld by octree decoding and then trisoup decode the second child node (leaf node) in list La iteratively. Thus, there is only a small latency between octree decoding and trisoup decoding.
         During the trisoup decoding process, the information of each leaf node is decoded from dedicated bitstream.

Encoding method in the first embodiment:

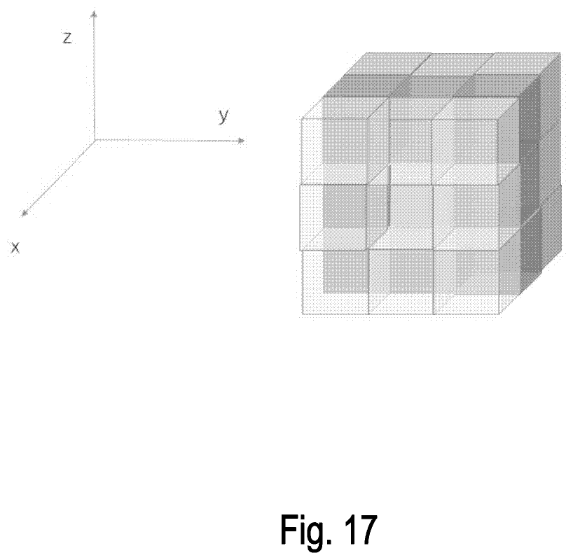

In the first embodiment, trisoup encoding is in parallel with octree encoding at the last depth of octree coding of occupancy tree. Since one edge may be shared between several neighbouring leaf nodes, in trisoup coding, the vertex information for an edge may not be determined if only one node information is known. As is shown in FIG. 17, taking the edge in the middle(left) as an example, only if the occupancy information of the 4 nodes (sharing the edge) are known, the vertex information of the edge can be obtained and then the vertex information of the edge can be encoded. Since the nodes of octree encoding are in raster scan order, so the trisoup encoding can start only after several nodes are coded by octree coding, it doesn't need to start after waiting for octree coding of all nodes at last depth finishes as that in prior art. The last depth of octree coding and trisoup coding can be implemented in parallel, and there are only several nodes delay between trisoup coding and last depth of octree coding.

In an example of parallel octree and trisoup encoding in the first embodiment, wherein the child nodes are coded in raster scan order. Assume leaf nodes are at depth d in octree, it uses octree coding for occupancy tree of nodes until depth d−1, and uses trisoup encoding to encode trisoup information of leaf nodes at depth d, the proposed encoder follows these steps:
Firstly, it uses octree coding to encode the occupancy of nodes in raster scan order until depth d−1, and also during this process child nodes of nodes at depth d−2 are put into a list L_{d-1}, so it can obtain a list L_{d-1} storing nodes in raster scan order, which can be used for last depth of octree coding, which is at depth d−1;
Then for nodes at depth d−1, the octree encoding of nodes crosses with trisoup coding by making use of the advantage of raster scan ordered nodes. For an example, in detail,
   Obtain a list L_{d-1} storing nodes at depth d−1 in raster scan order;
   Process node Nₖ (k starts from 0) from the list L_{d-1}, and encode its child nodes (leaf nodes) in raster scan order as described in the preciously described method and put child nodes at depth d in list L_{d}.
      From the start of coding the first child node, the node information of each child node is stored in a buffer Ltris after it is encoded by octree coding, which can be used for trisoup coding of these already coded child nodes.
      And when the sIdx and tIdx of current child node satisfy the condition (which is sIdx=1 and tIdx=1) for the first time, after current child node is encoded, the trisoup coding starts from the first child node (whose sIdx and tIdx are 0) of N₀, which is also the first child node in L_{d}. So the buffer Ltris stores node information of
         child nodes of a slice of nodes with same x and a tube of nodes with same x and y, which locates in raster scan order before current child node,
         and current child node,
         and they are shown in FIG. 18, wherein the transparent green node represents the current child node, and the nodes in transparent pink, yellow and orange are child nodes that are already coded. After octree coding of the current child node, put its information into buffer Ltris if it's occupied, then information of all neighbouring child nodes of first child node is known, the vertex determination of each edge of first child node (which is first leaf node) in list Ld can be done, so the trisoup coding can be started from this child node.
      Then encode the next child node stored in list Ld by octree encoding and then trisoup encode the second child node (leaf node) in list La iteratively. Thus, there is only a small latency between octree coding and trisoup coding.
         During the trisoup encoding process, put the trisoup information bitstream of each leaf node into a buffer.

Finally, append the bitstream of trisoup information at the end of the octree bitstream once octree encoding is finished, so octree information bitstream and trisoup information bitstream are in separate parts of a DU.

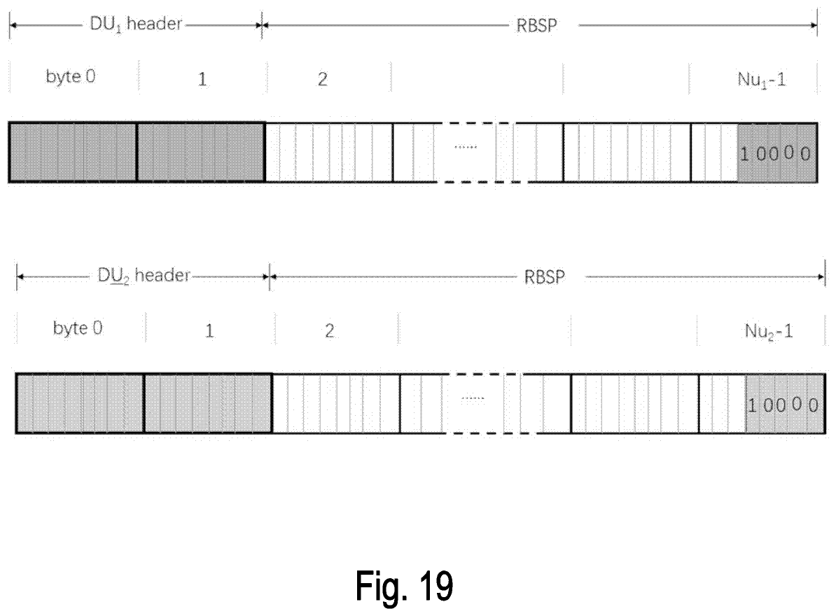

In the second embodiment, it also uses the same ordering of the nodes for both octree coding and trisoup coding, for instance raster scan order, and to achieve parallel of octree coding and trisoup coding at both encoder and decoder, and also to simplify processing at the encoder side (and not have to concatenate a buffered bitstream), octree and trisoup information of a point cloud slice may be encoded into separate data units (DUs). The entire encoding process is the same as that in the first embodiment, and the difference is that there are two DUs for each slice of point cloud data, and for an example DU₁ is for occupancy information byte sequence payload of a data unit with Nu₁ bytes, and DU₂ is for trisoup information byte sequence payload of a data unit with Nu2 bytes, which is shown in FIG. 19.

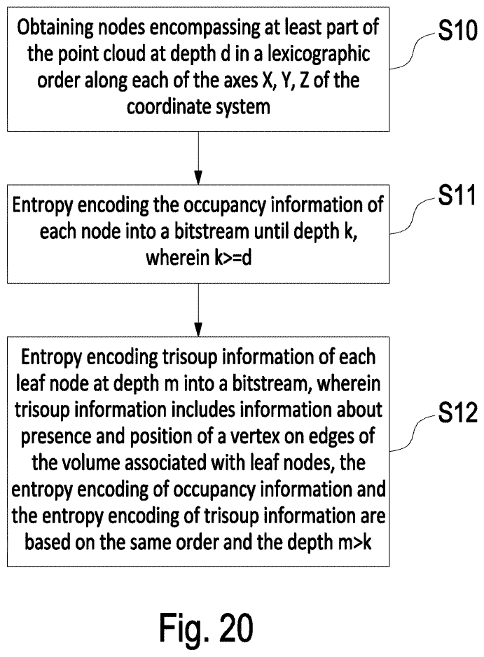

Referring to FIG. 20 showing a schematic flow diagram of the method for encoding a 3D point clod into a bitstream according to the present disclosure.

The method includes:

In step S10, nodes encompassing at least part of the point cloud at depth d in a lexicographic order along each of the axes X, Y, Z of the coordinate system is obtained;

In step S11, the occupancy information of each node until depth k is entropy encoded into a bitstream, wherein k>=d;

In step S12, trisoup information of each leaf node at depth m is encoded into a bitstream, wherein trisoup information includes information about presence and position of a vertex on edges of the volume associated with leaf nodes, and wherein the entropy encoding of occupancy information and the entropy encoding of trisoup information are based on the same order and the depth m>k.

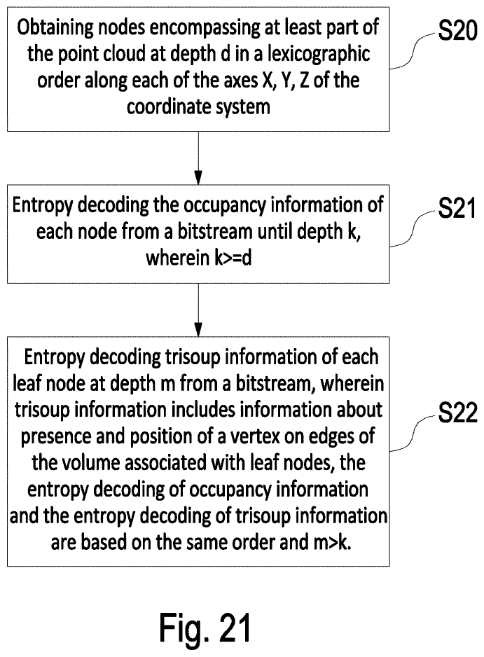

Referring to FIG. 21 showing a schematic flow diagram of the method for decoding a 3D point cloud from a bitstream according to the present disclosure.

The method includes:

In step S20, nodes encompassing at least part of the point cloud at depth d in a lexicographic order along each of the axes X, Y, Z of the coordinate system is obtained;

In step S21, the occupancy information of each node until depth k is entropy decoded from a bitstream, wherein k>=d;

In step S22, trisoup information of each leaf node at depth m is decoded from a bitstream, wherein trisoup information includes information about presence and position of a vertex on edges of the volume associated with leaf nodes, and wherein the entropy decoding of occupancy information and the entropy decoding of trisoup information are based on the same order and the depth m>k.

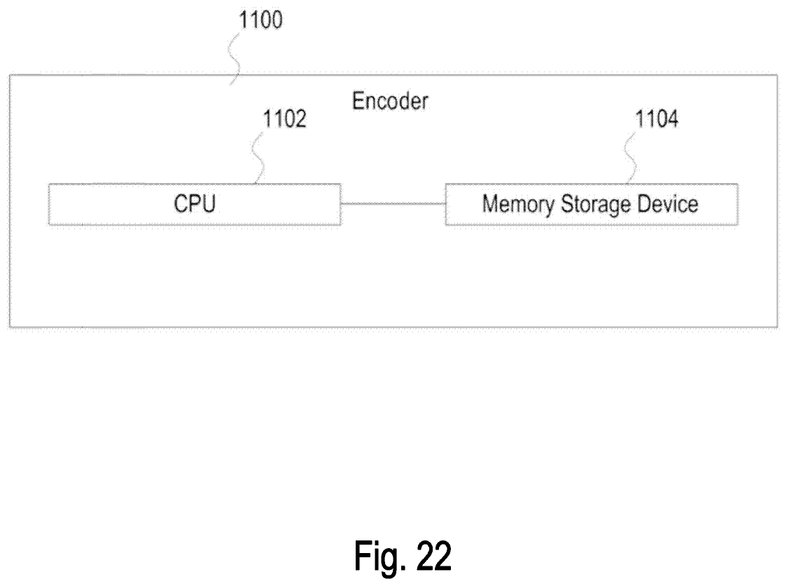

Reference is now made to FIG. 22, which shows a simplified block diagram of an example embodiment of an encoder 1100. The encoder 1100 includes a processor 1102 and a memory storage device 1104. The memory storage device 1104 may store a computer program or application containing instructions that, when executed, cause the processor 1102 to perform operations such as those described herein. For example, the instructions may encode and output bitstreams encoded in accordance with the methods de-scribed herein. It will be understood that the instructions may be stored on a non-transitory computer-readable medium, such as a compact disc, flash memory device, random access memory, hard drive, etc. When the instructions are executed, the processor 1102 carries out the operations and functions specified in the instructions so as to operate as a special-purpose processor that implements the described process(es). Such a processor may be referred to as a “processor circuit” or “processor circuitry” in some examples.

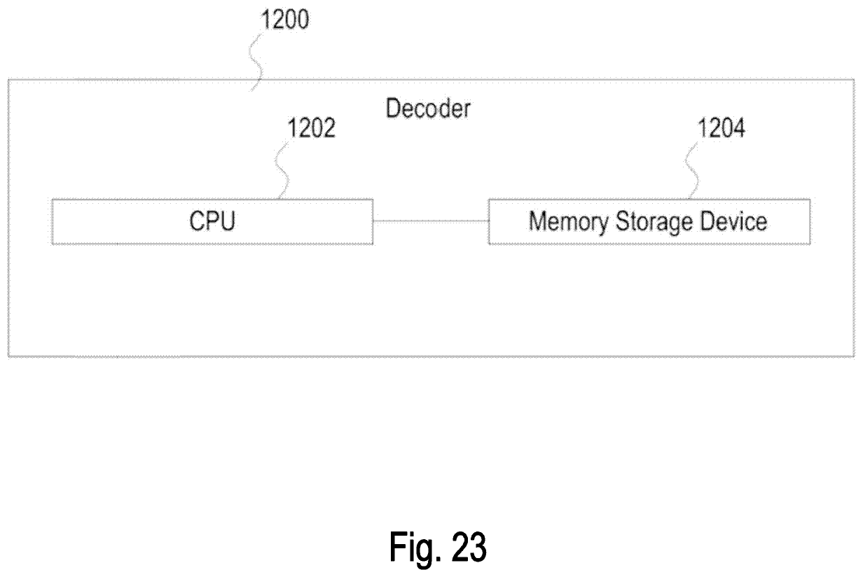

Reference is now also made to FIG. 23, which shows a simplified block diagram of an example embodiment of a decoder 1200. The decoder 1200 includes a processor 1202 and a memory storage device 1204. The memory storage device 1204 may include a computer program or application containing instructions that, when executed, cause the processor 1202 to perform operations such as those described herein. It will be understood that the instructions may be stored on a computer-readable medium, such as a compact disc, flash memory device, random access memory, hard drive, etc. When the instructions are executed, the processor 1202 carries out the operations and functions specified in the instructions so as to operate as a special-purpose processor that implements the described process(es) and methods. Such a processor may be referred to as a “processor circuit” or “processor circuitry” in some examples.

It will be appreciated that the decoder and/or encoder according to the pre-sent application may be implemented in a number of computing devices, including, without limitation, servers, suitably programmed general purpose computers, machine vision systems, and mobile devices. The decoder or encoder may be implemented by way of software containing instructions for configuring a processor or processors to carry out the functions described herein. The software instructions may be stored on any suitable non-transitory computer-readable memory, including CDs, RAM, ROM, Flash memory, etc.

It will be understood that the decoder and/or encoder described herein and the module, routine, process, thread, or other software component implementing the described method/process for configuring the encoder or decoder may be realized using standard computer programming techniques and languages. The present application is not limited to particular processors, computer languages, computer programming conventions, data structures, other such implementation details. Those skilled in the art will recognize that the described processes may be implemented as a part of computer-executable code stored in volatile or non-volatile memory, as part of an application-specific integrated chip (ASIC), etc.

The present application also provides for a computer-readable signal encoding the data produced through application of an encoding process in accordance with the present application.

Certain adaptations and modifications of the described embodiments can be made. Therefore, the above discussed embodiments are considered to be illustrative and not restrictive. In particular, embodiments can be freely combined with each other.

1. A method for encoding a 3D point cloud into a bitstream, implemented in an encoder, a geometry of the point cloud being defined in an oetree octree-based structure having a plurality of nodes having parent-child relationships and representing a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure and wherein occupancy information associated with each respective child sub-volume indicates whether that respective child sub-volume contains at least one of the points, the method comprising:
obtaining nodes encompassing at least part of the point cloud at a depth d in a lexicographic order along each of axes X, Y, Z of the coordinate system;
entropy encoding the occupancy information of each node into a bitstream until a depth k, wherein k>=d; and
entropy encoding trisoup information of each leaf node at a depth m into a bitstream, wherein the trisoup information includes information about presence and position of a vertex on edges of the volume associated with leaf nodes;
wherein the entropy encoding of the occupancy information and the entropy encoding of the trisoup information are based on the same order and the depth m>k.

2. A method for decoding a 3D point cloud from a bitstream, implemented in a decoder, a geometry of the point cloud being defined in an octree-based structure having a plurality of nodes having parent-child relationships and representing a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure and wherein occupancy information associated with each respective child sub-volume indicates whether that respective child sub-volume contains at least one of the points, the method comprising:
obtaining nodes encompassing at least part of the point cloud at a depth d in a lexicographic order along each of axes X, Y, Z of the coordinate system;
entropy decoding the occupancy information of each node from a bitstream until a depth k, wherein k>=d; and
entropy decoding trisoup information of each leaf node at a depth m from a bitstream, wherein the trisoup information includes information about presence and position of a vertex on edges of the volume associated with leaf nodes;
wherein the entropy decoding of the occupancy information and the entropy decoding of the trisoup information are based on the same order and m>k.

3. The method according to claim 1, further comprising:
storing occupied child nodes at a depth d+1 in a lexicographic order.

4. The method according to claim 1, wherein at least one of the lexicographic order of nodes at the depth d or a lexicographic order of child nodes at a depth d+1 is a raster scan order.

5. The method according to claim 2, wherein the entropy decoding of the trisoup information is in parallel with the entropy decoding of the occupancy information at a last depth of the entropy decoding of the occupancy information.

6. The method according to claim 1, wherein the entropy encoding of the trisoup information is in parallel with the entropy encoding of the occupancy information at a last depth of the entropy encoding of the occupancy information with a latency being a subset of the leaf nodes.

7. The method according to claim 1, wherein the occupancy information and the trisoup information are encoded into two independent sections of a bitstream, and the trisoup information starts on an addressable bit or byte of the bitstream.

8. The method according to claim 1, wherein the occupancy information and the trisoup information are encoded into two separate bitstreams.

9. An encoder to encode a 3D point cloud into a bitstream, comprising:
at least one processor; and
a memory, storing instructions executable by the processor;
wherein the processor is configured to perform the method according to claim 1.

10. A decoder to decode a 3D point cloud from a bitstream, comprising:
at least one processor; and
a memory, storing instructions executable by the processor;
wherein the processor is configured to perform the method according to claim 2.

11. (canceled)

12. A non-transitory computer-readable storage medium storing instructions that, when executed by a processor, cause the processor to perform the method according to claim 1.

13. The method according to claim 2, further comprising:
storing occupied child nodes at a depth d+1 in a lexicographic order.

14. The method according to claim 2, wherein at least one of the lexicographic order of nodes at the depth d or a lexicographic order of child nodes at a depth d+1 is a raster scan order.

15. The method according to claim 3, wherein at least one of the lexicographic order of nodes at the depth d or the lexicographic order of child nodes at the depth d+1 is a raster scan order.

16. The method according to claim 2, wherein the entropy decoding of the trisoup information is in parallel with the entropy decoding of the occupancy information at a last depth of the entropy decoding of the occupancy information with a latency being a subset of the leaf nodes.

17. The method according to claim 2, wherein the occupancy information and the trisoup information are decoded from two independent sections of a bitstream, and the trisoup information starts on an addressable bit or byte of the bitstream.

18. The method according to claim 2, wherein the occupancy information and the trisoup information are decoded from two separate bitstreams.
